(19) United States
(12) Patent Application Publication
(10) Pub. No.: US 2024/0333345 A1
(43) Pub. Date: Oct. 3, 2024

(54) RADIO COMMUNICATION SYSTEM, TRANSMISSION APPARATUS AND RECEPTION APPARATUS

(71) Applicant: NIPPON TELEGRAPH AND TELEPHONE CORPORATION, Tokyo (JP)

(72) Inventors: Tomoya KAGEYAMA, Tokyo (JP); Doohwan LEE, Tokyo (JP); Takayuki YAMADA, Tokyo (JP); Jun MASHINO, Tokyo (JP); Hirofumi SASAKI, Tokyo (JP); Yasunori YAGI, Tokyo (JP)

(21) Appl. No.: 18/578,081

(22) PCT Filed: Jul. 13, 2021
(86) PCT No.: PCT/JP2021/026310

§ 371 Date: Jan. 10, 2024

(51) Int. Cl. H04B 7/0413

(52) U.S. Cl. CPC H04B 7/0413

(57) ABSTRACT

A wireless communication system includes a transmission apparatus and a reception apparatus, in which the transmission apparatus includes a plurality of UCAs having a first UCA and a second UCA, the reception apparatus includes a third UCA, a transmission axis of the first UCA and a transmission axis of the second UCA are directed in different directions, and the first UCA faces the third UCA.

### TECHNICAL FIELD

The present invention relates to a technique of spatially multiplexing and transmitting wireless signals by using the orbital angular momentum (OAM) of electromagnetic waves.

### BACKGROUND ART

In recent years, a technique for improving a transmission capacity by spatially multiplexing and transmitting wireless signals by using OAM has been studied (for example, Non Patent Literature 1). In electromagnetic waves having OAM, an equiphase surface is spirally distributed in a propagation direction around a propagation axis. Since electromagnetic waves having different OAM modes and propagating in the same direction have spatial phase distributions orthogonal to each other in a rotation axis direction, it is possible to multiplex and transmit signals by separating signals in respective OAM modes modulated with different signal sequences in a reception device.

In a wireless communication system using the OAM multiplexing technique, spatial multiplexing transmission of different signal sequences can be realized by generating, combining, and transmitting a plurality of OAM modes by using a uniform circular array (hereinafter referred to as a UCA) in which a plurality of antenna elements are circularly arranged at equal intervals (for example, Non Patent Literature 2). For example, a Butler circuit (Butler matrix circuit) is used for signal generation and signal separation in a plurality of OAM modes.

### Citation List

### Non Patent Literature

Non Patent Literature 1: J. Wang et al., “Terabit free-space data transmission employing orbital angular momentum multiplexing,” Nature Photonics, Vol. 6, pp. 488-496, July 2012.

Non Patent Literature 2: Y. Yan et al., “High-capacity millimeter-wave communications with orbital angular momentum multiplexing,” Nature Commun., vol. 5, p. 4876 September 2014.

### SUMMARY OF INVENTION

### Technical Problem

As described above, large-capacity communication can be performed with a transmission device and a reception device using a UCA, but in the future, it is desired to handle a cellular system, particularly to apply the cellular system to an access line.

However, in the conventional wireless transmission technology using a UCA, in order to separate signals in a plurality of OAM modes without interference between the modes, it is necessary to install a transmission antenna and a reception antenna at positions at which the antennas face each other, and thus it is necessary to perform axial alignment. Therefore, multidirectional support is difficult. Accurate axial alignment is difficult, and there is a possibility that inter-mode interference will occur due to axial deviation between the transmission antenna and the reception antenna, and thus a reduction in transmission capacity be caused.

The present invention has been made in view of the above circumstances, and an object of the present invention is to provide a technology that enables multidirectional support and inter-mode interference reduction in a wireless transmission technology using a UCA.

### Solution to Problem

According to the disclosed technology, there is provided a wireless communication system including a transmission apparatus and a reception device, in which the transmission apparatus includes a plurality of UCAs having a first UCA and a second UCA, and the reception device includes a third UCA, and a transmission axis of the first UCA and a transmission axis of the second UCA are directed in different directions, and the first UCA faces the third UCA.

### Advantageous Effects of Invention

According to the disclosed technology, there is provided a technology that enables multidirectional support and inter-mode interference reduction in a wireless transmission technology using a UCA.

### BRIEF DESCRIPTION OF DRAWINGS

FIG. 1 is a diagram illustrating a phase setting example of a UCA for generating a signal in an OAM mode.

FIG. 2 is a diagram illustrating an example of a phase distribution and a signal intensity distribution of an OAM multiplex signal.

FIG. 3 is an outline configuration diagram illustrating a communication system according to an embodiment of the present invention.

FIG. 4 is a diagram for describing an outline of an operation.

FIG. 5 is a diagram for describing an outline of an operation.

FIG. 6 is a sequence diagram illustrating a flow of a process.

FIG. 7 is a sequence diagram illustrating a flow of a process.

FIG. 8 is a sequence diagram illustrating a flow of a process.

FIG. 9 is a diagram for describing an operation example.

FIG. 10 is a diagram for describing an operation example.

FIG. 11 is a diagram illustrating a configuration example of a transmission device according to the embodiment of the present invention.

FIG. 12 is a diagram illustrating a configuration example of a reception device according to the embodiment of the present invention.

### DESCRIPTION OF EMBODIMENTS

An embodiment (the present embodiment) of the present invention will be described below with reference to the drawings. The embodiment described below is merely an example, and embodiments to which the present invention is applied are not limited to the embodiment described below.

### Basic Operation Example

First, a basic setting/operation example related to a UCA used in a transmission device (transmission apparatus) and a reception device (reception apparatus) in the present embodiment will be described.

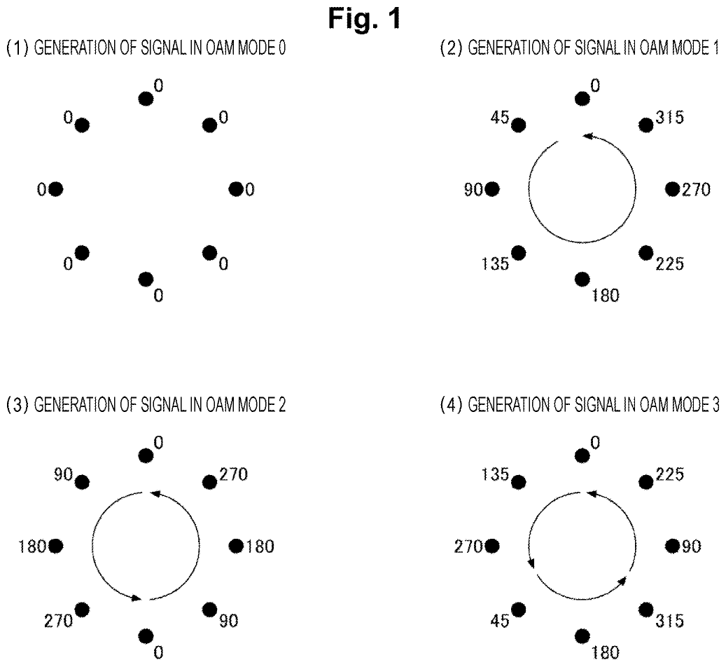

FIG. 1 illustrates a phase setting example of a UCA for generating a signal in an OAM mode. The UCA illustrated in FIG. 1 is a UCA including eight antenna elements.

In FIG. 1, signals in the OAM modes 0, 1, 2, 3, . . . on a transmission side are generated by phase differences of signals supplied to the antenna elements (indicated by ⋅) of the UCA. That is, a signal in an OAM mode n is generated by setting a phase of the signal to be supplied to each antenna element such that the phase rotates by n (n×360 degrees). For example, in a case where the UCA includes m=8 antenna elements as illustrated in FIG. 1, and a signal in the OAM mode n=2 is generated, as illustrated in FIG. 1 (3), a phase difference (0 degrees, 90 degrees, 180 degrees, 270 degrees, 0 degrees, 90 degrees, 180 degrees, 270 degrees) of 360 n/m=90 degrees is set in each antenna element counterclockwise such that the phase rotates twice.

A signal of which a phase rotation direction is reversed to the signal in the OAM mode n is referred to as an OAM mode-n. For example, a phase rotation direction of a signal in a positive OAM mode is set to the counterclockwise direction, and a phase rotation direction of a signal in a negative OAM mode is set to the clockwise direction.

Wireless communication using spatial multiplexing can be performed by generating different signal sequences as signals in different OAM modes and simultaneously transmitting the generated signals. The transmission side may generate and combine signals to be transmitted in each OAM mode in advance, and transmit a combined signal of each OAM mode by a single UCA, or may transmit a signal of each OAM mode by a different UCA for each OAM mode by using a plurality of UCAs. Further, OAM-MIMO multiplex transmission can be performed by a plurality of UCAs.

In order to separate an OAM multiplex signal on a reception side, a phase of each antenna element of a UCA on the reception side may be set to be reverse to a phase of an antenna element on the transmission side. Further, in order to separate signals of OAM-MIMO multiplex transmission, a MIMO technology such as MIMO equalization is used.

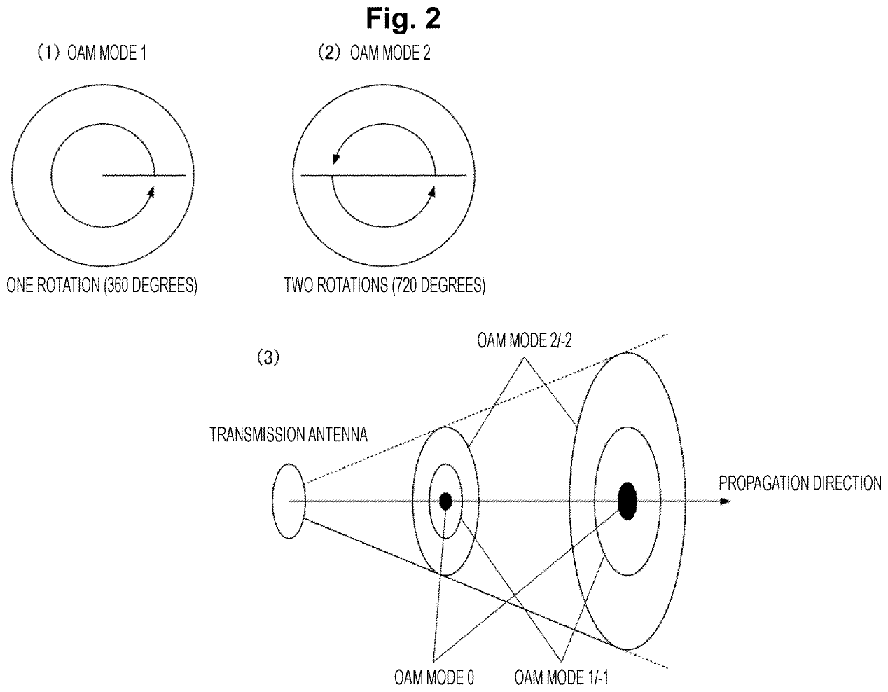

FIG. 2 illustrates an example of a phase distribution and a signal intensity distribution of an OAM multiplex signal. In FIGS. 2(1) and 2(2), phase distributions of signals in OAM mode 1 and OAM mode 2 viewed from the transmission side at an end face (propagation orthogonal plane) orthogonal to the propagation direction are indicated by arrows. The beginning of the arrow is 0 degrees, the phase changes linearly, and the end of the arrow is 360 degrees. That is, the signal in the OAM mode n propagates while the phase rotates by n (n×360 degrees) in the propagation orthogonal plane. The arrows of phase distributions of the signals in the OAM modes −1 and −2 are in reverse directions.

In the signal in each OAM mode, a signal intensity distribution and a position where the signal intensity is maximized are different for each OAM mode. However, the intensity distributions of the same OAM mode having different signs are the same. Specifically, as the OAM mode becomes higher, a position where the signal intensity is maximized becomes farther from the propagation axis (Non Patent Literature 2). Here, a mode having a greater value in the OAM mode will be referred to as a higher mode. For example, the signal in the OAM mode 3 is in a higher mode than the signals in the OAM mode 0, the OAM mode 1, and the OAM mode 2.

In FIG. 2(3), a position where the signal intensity is maximized is indicated by a circular ring for each OAM mode. As the OAM mode becomes higher, the position where the signal intensity is maximized becomes farther from the central axis, and a beam diameter of the OAM mode multiplex signal widens according to a propagation distance, and the circular ring indicating the position where the signal intensity is maximized widens for each OAM mode.

### Outline of Embodiment of Present Invention

As described above, large-capacity communication can be performed with the transmission device (transmission apparatus) and the reception device (reception apparatus) using the UCA. However, since it is necessary to install the transmission antenna and the reception antenna at positions where the antennas face each other, multidirectional support is difficult. Even if the transmission and reception antennas are installed at the facing positions, inter-mode interference due to axial deviation between the transmission and reception antennas is likely to occur.

In the present embodiment, a technology for enabling multidirectional support, reducing inter-mode interference, and enabling large-capacity transmission between devices will be described. Hereinafter, examples of a system configuration and an operation in the present embodiment will be described in detail.

### System Configuration

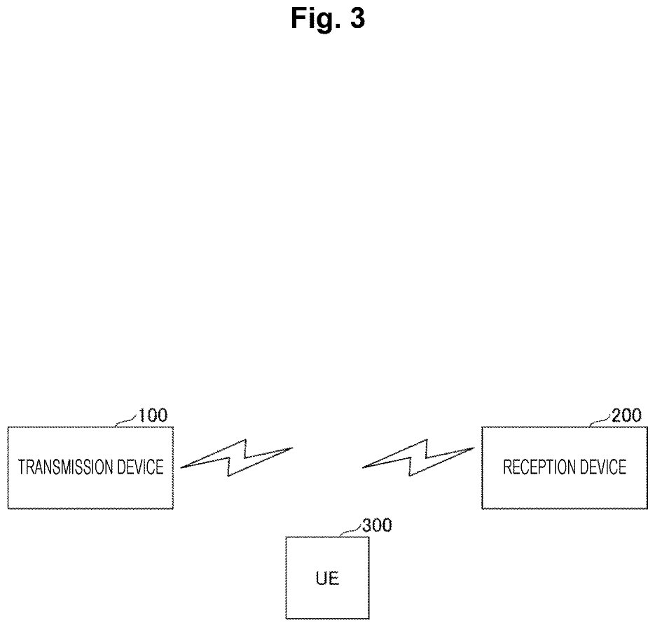

FIG. 3 illustrates an outline configuration example of a wireless communication system in the present embodiment. As illustrated in FIG. 3, the wireless communication system in the present embodiment includes a transmission device 100 (transmission apparatus) and a reception device 200 (reception apparatus). A UE 300 that is a terminal is present in any place. Note that the UE 300 may not be present.

Each of the transmission device 100 and the reception device 200 includes a UCA. In transmission and reception of the desired data, the transmission device 100 multiplexes and transmits signals in one or more OAM modes, and the reception device 200 receives the signal in which the one or more OAM modes are multiplexed and transmitted from the transmission device 100 and separates the signals in the respective OAM modes. Both the transmission device 100 and the reception device 200 can also perform MIMO multiplex transmission. OAM multiplex transmission and MIMO multiplex transmission may be referred to as OAM transmission and MIMO transmission.

The UE 300 may support MIMO multiplex transmission and not support OAM multiplex transmission, or may support OAM multiplex transmission and not support MIMO multiplex transmission, or the UE 300 may support both MIMO multiplex transmission and OAM multiplex transmission.

In the present embodiment, it is assumed that both the transmission device 100 and the reception device 200 are devices that do not move (for example, base stations). However, such an assumption is an example.

### Operation Outline

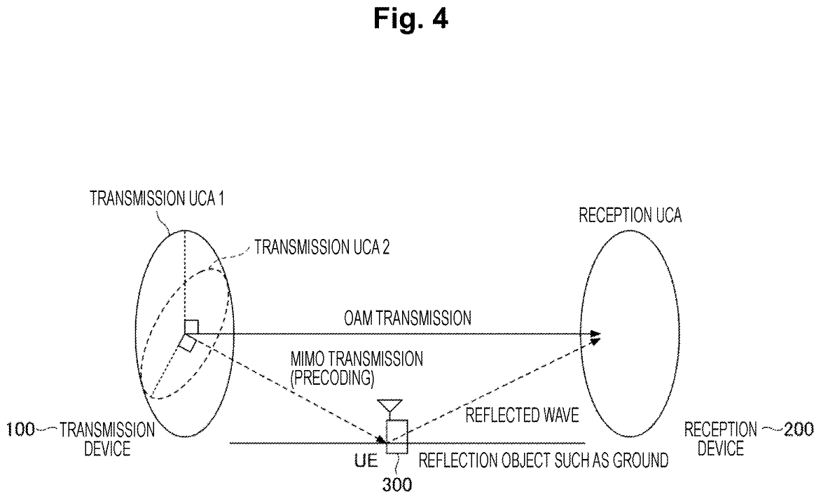

An operation outline of the wireless communication system according to the present embodiment will be described with reference to FIG. 4. The transmission device 100 includes two UCAs (referred to as a transmission UCA 1 and a transmission UCA 2), and the reception device 200 includes one UCA (referred to as a reception UCA). Note that the transmission device 100 may include three or more UCAs, and one of the UCAs may face the reception UCA. The reception device 200 may also include two or more UCAs.

In the transmission device 100, a transmission axis of the transmission UCA 1 and a transmission axis of the transmission UCA 2 are directed in different directions. The transmission UCA 1 and the reception UCA are disposed to face each other. The transmission UCA 1 and the reception UCA face each other, but do not need to have accurate axial alignment.

In the example illustrated in FIG. 4, the transmission device 100 performs signal transmission to the reception UCA by OAM transmission using the transmission UCA 1, and performs MIMO transmission using precoding using the transmission UCA 2. Note that OAM transmission can be performed by the transmission UCA 2.

The transmission device 100 adaptively uses the transmission UCA 2 by switching between the following two applications (1) and (2) for use.

(1) The transmission UCA 2 is used to perform communication using MIMO transmission (or OAM transmission) with the UE 300 disposed at a position different from the reception UCA.

(2) A signal that reaches the reception UCA from the transmission UCA 2 by using a reflected wave or the like is used to reduce inter-mode interference due to axial deviation between the transmission UCA 1 and the reception UCA.

Note that (1) and (2) may be performed simultaneously. FIG. 4 illustrates an image in which a radio wave from the transmission UCA 2 is reflected on the ground and the reflected wave reaches the reception UCA, but using a reflected wave from the ground is an example. The reflected wave may be a reflected wave from a building or the like.

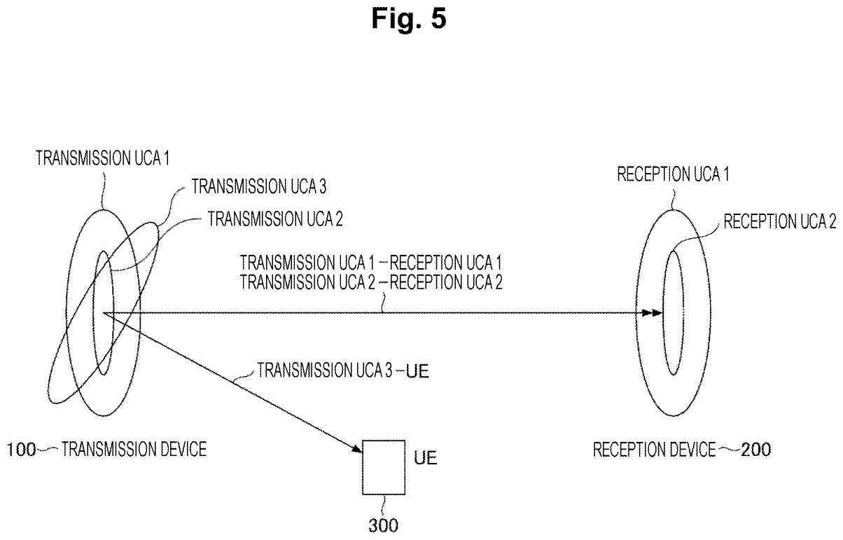

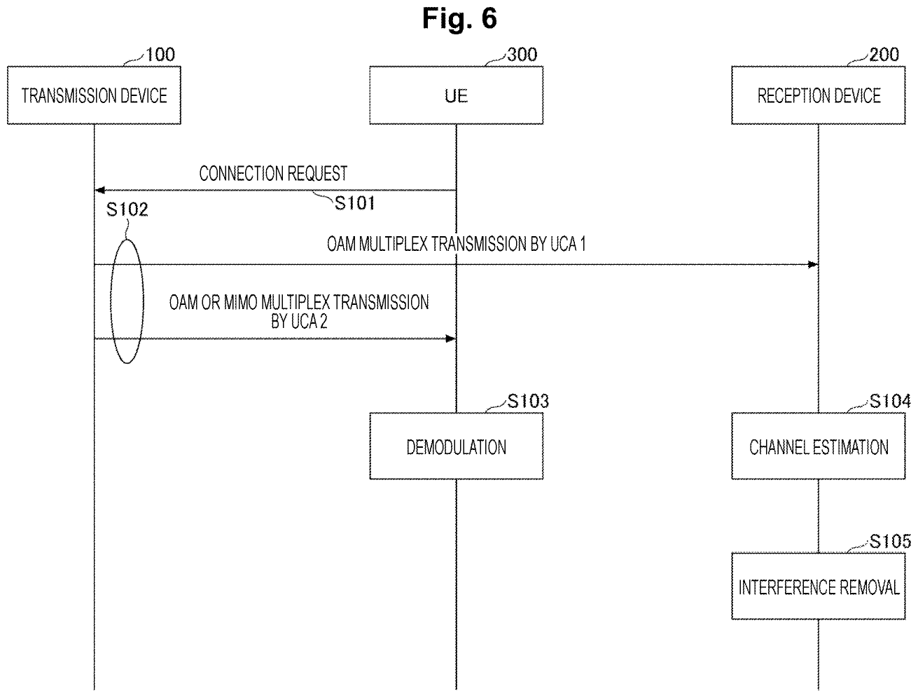

FIG. 4 (and the example described in FIG. 6 and subsequent drawings) illustrates a case where each of the transmission UCA 1 and the reception UCA of the transmission device 100 is one UCA, but this is an example. As illustrated in FIG. 5, the transmission device 100 and the reception device 200 may perform OAM-MIMO multiplex transmission using two or more facing UCAs. In the example in FIG. 5, the transmission device 100 includes three UCAs such as a transmission UCA 1, a transmission UCA 2, and a transmission UCA 3. The reception device 200 includes two UCAs such as a reception UCA 1 and a reception UCA 2. Even in a case where each of the transmission device 100 and the reception device 200 performs OAM-MIMO multiplex transmission by using two or more facing UCAs, a basic operation is similar to the operations described in the above (1) and (2) and the following description.

### Detailed Operation Example

A more detailed operation example based on the configuration in FIG. 4 will be described with reference to

FIGS. 6 to 8. Hereinafter, a case where the UE 300 is present and a case where the UE 300 is not present will be described.

### Case Where UE 300 is Present

An operation example in a case where the UE 300 is present will be described along the sequence illustrated in FIG. 6. Note that “the UE 300 is present” means that, for example, the UE 300 is present at a position where a signal transmitted from the transmission UCA 2 can be received and appropriately demodulated.

In S101 (step 101), the UE 300 makes a connection request with respect to the transmission device 100. The UE 300 notifies which one of the OAM multiplex transmission and the MIMO multiplex transmission is used in signal reception from the transmission device 100 in response to the connection request.

In S102, the transmission device 100 transmits a signal based on OAM multiplex transmission toward the reception UCA of the reception device 200 by using the transmission UCA 1, and simultaneously transmits a signal based on OAM multiplex transmission or MIMO multiplex transmission to the UE 300 in response to a request from the UE 300 by using the transmission UCA 2. In the present example, it is assumed that the signal transmitted from the transmission UCA 2 reaches the UE 300 and also reaches the reception device 200 due to reflection from the ground or the like.

Note that the transmission device 100 adds a preamble to the signals transmitted from the transmission UCAs 1 and 2 and transmits the signals. The preamble is a signal with a fixed pattern added to a head of a transmission signal (transmission packet), and the reception side can perform channel estimation and the like by using the preamble. The preamble may be referred to as a known signal. In the present embodiment, a plurality of orthogonal preambles (orthogonal sequences) are used. The orthogonal preamble is transmitted, for example, for each UCA and for each mode.

In S103, the UE 300 receives a signal from the transmission device 100 and demodulates the signal. In S104, the reception device 200 performs channel estimation by using the orthogonal preamble added to each of the transmission signal from the transmission UCA 1 and the transmission signal from the transmission UCA 2.

In S105, the reception device 200 removes (reduces) the interference from the transmission UCA 2 and demodulates the signal from the transmission UCA 1 by using the channel estimated in S104. The interference removal may be performed by using digital signal processing such as a MIMO equalization process, a channel equalization process, and a successive interference cancellation process.

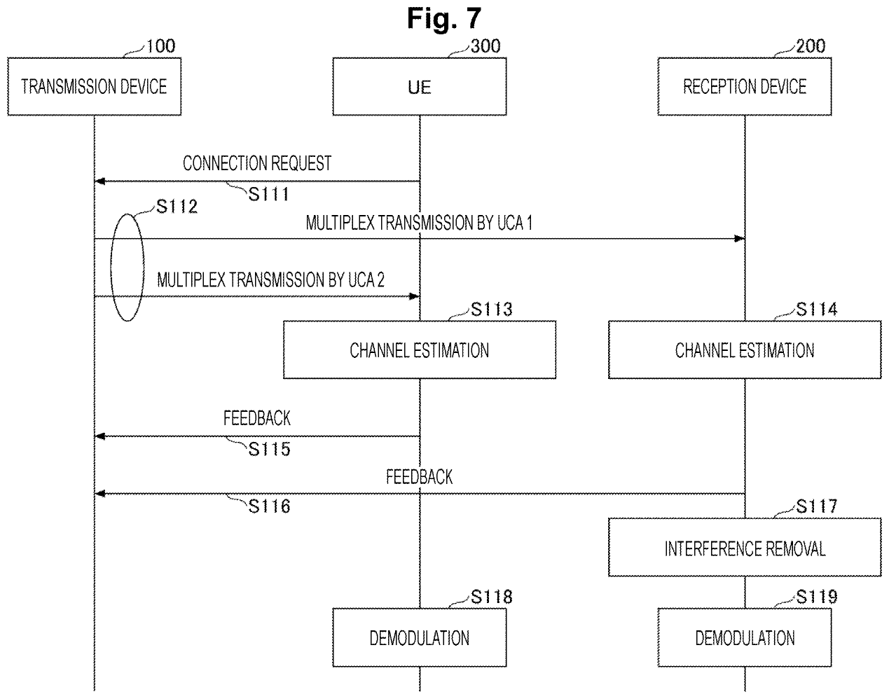

The sequence illustrated in FIG. 6 is an example, and other sequences may be used. For example, an operation in the sequence illustrated in FIG. 7 may be performed.

S111 and S112 in FIG. 7 are the same as S101 and S102 in FIG. 6. In S113 in FIG. 7, the UE 300 performs channel estimation by using the preamble received from the transmission UCA 2, and feeds back a channel estimation result to the transmission device 100 in S115. The transmission device 100 precodes a signal for the UE 300 by using the received feedback and transmits the precoded signal from the UCA 2. In S118, US300 demodulates the signal.

Alternatively, the UE 300 may add a preamble to an uplink signal and transmit the uplink signal, and the transmission device 100 that has received the uplink signal may perform channel estimation on the basis of the preamble and use the channel estimation result for precoding.

On the other hand, in S114, the reception device 200 performs channel estimation by using the preamble added to each of the transmission signal from the transmission UCA 1 and the transmission signal from the transmission UCA 2, and feeds back a channel estimation result to the transmission device 100. The transmission device 100 uses the feedback for precoding the signal of the UCA 1. The reception device 200 performs interference removal in S117, and demodulates the signal from the transmission UCA 1 in S119.

Through the above operation, a channel between the reception device 200 and the UE 300, and the transmission device 100 can be acquired by the transmission device 100, and precoding that can simultaneously achieve a reduction in interference with the reception UCA and connection to the UE 300 can be performed.

The sequences in FIGS. 6 and 7 are based on the configuration in FIG. 4, but processing can be performed in a similar sequence even in a case where a sequence is based on the configuration illustrated in FIG. 5. Hereinafter, the sequences in FIGS. 6 to 7 in a case of being based on the configuration illustrated in FIG. 5 will be described. Hereinafter, portions different from the contents already described will be mainly described.

In S101 in FIG. 6, the UE 300 makes a connection request with respect to the transmission device 100. In S102, the transmission device 100 transmits a signal based on OAM-MIMO multiplex transmission to the reception UCA 1and the reception UCA 2 of the reception device 200 by using the transmission UCA 1 and the transmission UCA 2, and simultaneously transmits a signal based on OAM multiplex transmission or MIMO multiplex transmission to the UE 300 in response to a request from the UE 300 by using the transmission UCA 3.

In S103, the UE 300 receives a signal from the transmission device 100 and demodulates the signal. In S104, the reception device 200 performs channel estimation by using the orthogonal preamble added to each of the transmission signals from the transmission UCA 1 and the transmission UCA 2 and the transmission signal from the transmission UCA 3.

In S105, the reception device 200 removes (reduces) the interference from the transmission UCA 3 and demodulates the signals from the transmission UCA 1 and the transmission UCA 2 by using the channel estimated in S104.

The sequence illustrated in FIG. 6 is an example, and other sequences may be used. For example, an operation in the sequence illustrated in FIG. 7 may be performed.

S111 and S112 in FIG. 7 are the same as S101 and S102 in FIG. 6. In S113 in FIG. 7, the UE 300 performs channel estimation by using the preamble received from the transmission UCA 3, and feeds back a channel estimation result to the transmission device 100 in S115. The transmission device 100 precodes a signal for the UE 300 by using the received feedback and transmits the precoded signal from the UCA 3. In S118, US300 demodulates the signal.

On the other hand, in S114, the reception device 200 performs channel estimation by using the preambles added to each of the transmission signals from the transmission UCA 1 and the transmission UCA 2 and the transmission signal from the transmission UCA 3, and feeds back a channel estimation result to the transmission device 100. The transmission device 100 uses the feedback for precoding the signals of the UCA 1 and the UCA 2.

The reception device 200 performs interference cancellation in S117, and demodulates the signals from the transmission UCA 1 and the transmission UCA 2 in S119.

### Case Where UE 300 is Not Present

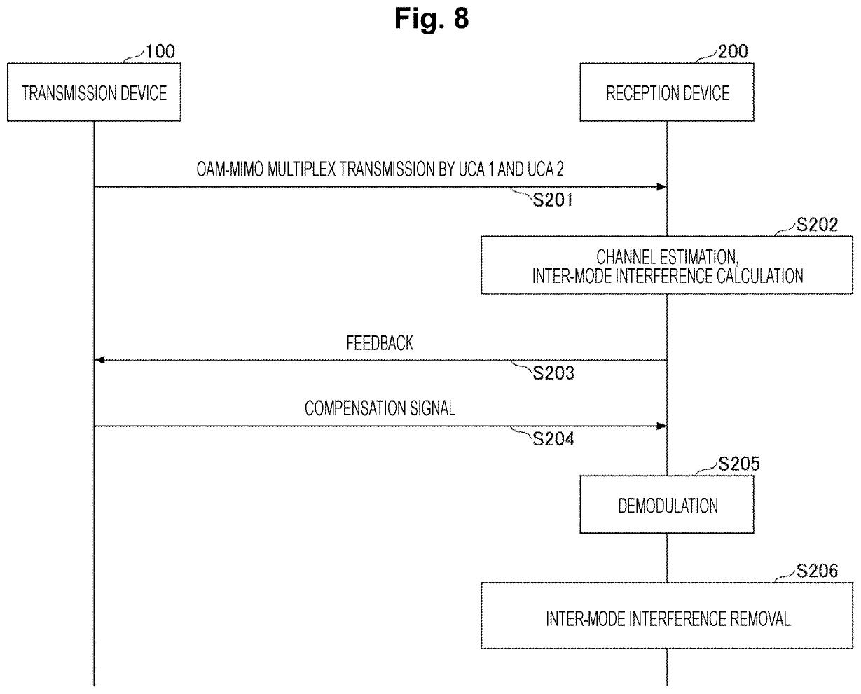

An operation example in a case where the UE 300 is not present will be described along the sequence illustrated in FIG. 8. In S201, the transmission device 100 transmits a signal to the reception device 200 according to OAM-MIMO multiplex transmission using the transmission UCA 1 and the transmission UCA 2. Here as well, the transmission device 100 adds an orthogonal preamble to each of signals to be transmitted from the transmission UCAs 1 and 2 and transmits the signals. The transmission signal from the transmission UCA 2 is reflected by the ground or the like and reaches the reception UCA.

In S202, the reception device 200 performs channel estimation by using the orthogonal preambles added to the transmission signals from the transmission UCAs 1 and 2, simultaneously calculates inter-mode interference, and feeds back the inter-mode interference information to the transmission device 100 in S203.

As an example, in a case where the transmission UCA 1 performs OAM multiplex transmission by multiplexing and transmitting the OAM mode 1 and the OAM mode 2, inter-mode interference occurs due to axial deviation between the transmission UCA 1 and the reception UCA. Due to the inter-mode interference, for example, part of the power of the signal transmitted from the transmission device 100 in the OAM mode 1 is obtained as the power of the signal in the OAM mode 2 in the reception device 200.

The inter-mode interference information may be any information as long as interference compensation (interference reduction) can be performed by using the inter-mode interference information. For example, information regarding a phase shift from a correct phase (the phase as illustrated in FIG. 1) of a signal in the OAM mode may be calculated and fed back to the transmission device 100 as the inter-mode interference information.

In S204, the transmission device 100 generates a compensation signal on the basis of the inter-mode interference information fed back from the reception device 200, and transmits the compensation signal from the transmission UCA 2 by using MIMO multiplexing.

In S205, the reception device 200 demodulates the compensation signal through MIMO equalization by using the channel estimated in S202, and in S206, demodulates the signal that is transmitted from the transmission UCA 1 according to OAM multiplex transmission by performing an inter-mode interference compensation process between the transmission UCA 1 and the reception UCA by using the compensation signal.

Note that reducing the inter-mode interference with the above-described “feedback+compensation signal” is an example. The reception device 200 may autonomously perform signal processing for reducing inter-mode interference by using the signal from the transmission UCA 2 (that is, by using a signal from a direction different from that of the transmission UCA 1).

Although the sequence in FIG. 8 is based on the configuration in FIG. 4, processing can be performed in a similar sequence even in a case where a sequence is based on the configuration illustrated in FIG. 5. Hereinafter, the sequence in FIG. 8 in a case of being based on the configuration illustrated in FIG. 5 will be described. Hereinafter, portions different from the contents already described will be mainly described.

In S201, the transmission device 100 transmits a signal to the reception device 200 according to OAM-MIMO multiplex transmission using the transmission UCA 1, the transmission UCA 2, and the transmission UCA 3.

In S202, the reception device 200 performs channel estimation by using the orthogonal preamble added to the transmission signal from each of the transmission UCAs 1, 2, and 3, simultaneously calculates inter-mode interference, and feeds back the inter-mode interference information to the transmission device 100 in S203.

As an example, in a case where the transmission UCA 1 and the transmission UCA 2 perform OAM-MIMO multiplex transmission by multiplexing and transmitting the OAM mode 1 and the OAM mode 2, inter-mode interference occurs due to axial deviation between the transmission UCA 1 and the transmission UCA 2, and the reception UCA 1 and the reception UCA 2. The inter-mode interference information for compensating for such inter-mode interference is fed back.

In S204, the transmission device 100 generates a compensation signal on the basis of the inter-mode interference information fed back from the reception device 200, and transmits the compensation signal from the transmission UCA 3 according to MIMO multiplexing.

In S205, the reception device 200 demodulates the compensation signal through MIMO equalization by using the channel estimated in S202, and in S206, performs an inter-mode interference compensation process between the transmission UCA 1 and the transmission UCA 2, and the reception UCA 1 and the reception UCA 2 by using the compensation signal, and thus demodulates the signals transmitted from the transmission UCA 1 and the transmission UCA 2 according to the OAM-MIMO multiplex transmission.

Note that reducing the inter-mode interference with the above-described “feedback +compensation signal” is an example. The reception device 200 may autonomously perform signal processing for reducing inter-mode interference by using a signal from the transmission UCA 3 (that is, by using a signal from a direction different from that of the transmission UCA 1 and the transmission UCA 2,).

### Summary of Operation Examples

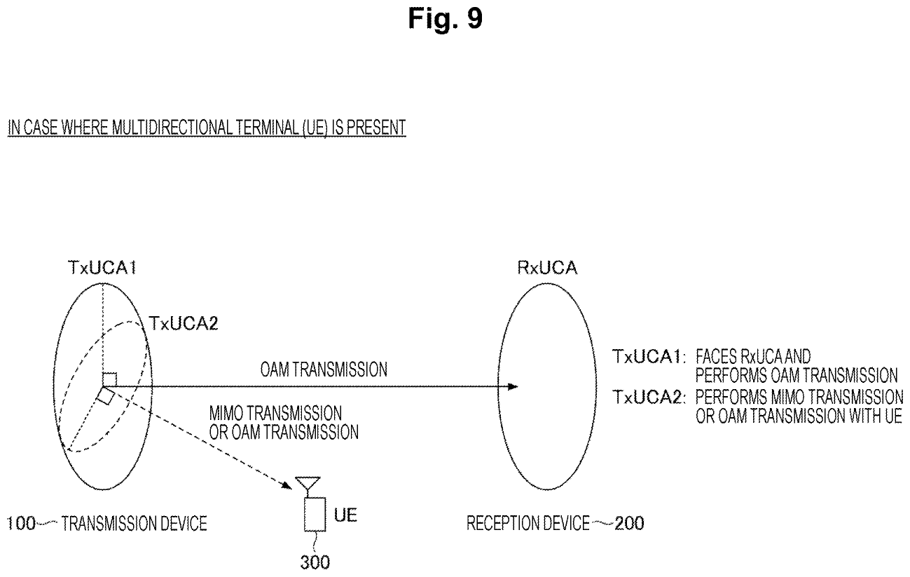

As illustrated in FIG. 9, in a case where the UE 300 is present, communication with the UE 300 can be performed by the transmission UCA 2, and thus communication with the UE 300 present in any direction can be performed. Therefore, multidirectional support can be realized. In a case where the reception UCA receives a reflected wave of the radio wave from the transmission UCA 2, the reception device 200 can remove the interference through the interference removal process.

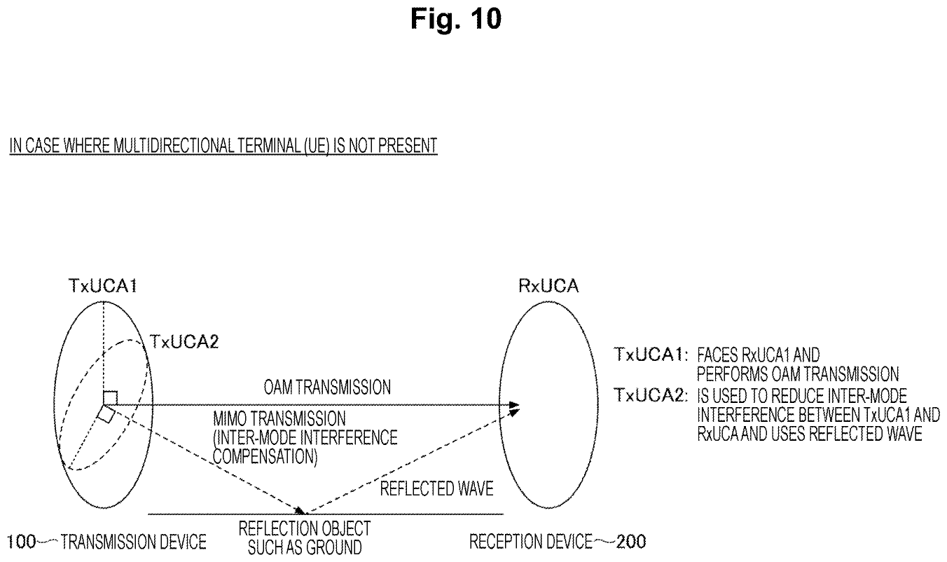

As illustrated in FIG. 10, in a case where the UE 300 is not present, the signal transmitted from the transmission UCA 2 can be used for reducing inter-mode interference caused by the axial deviation between the transmission UCA 1 and the reception UCA.

Note that the inter-mode interference reduction process illustrated in FIG. 10 is also applicable to a case where the UE 300 illustrated in FIG. 9 is present. That is, the process illustrated in FIG. 9 and the process illustrated in FIG. 10 may be combined.

### Device Configuration Example Next, device configuration examples of the transmission device 100 and the reception device 200 will be described.

### Transmission Device 100

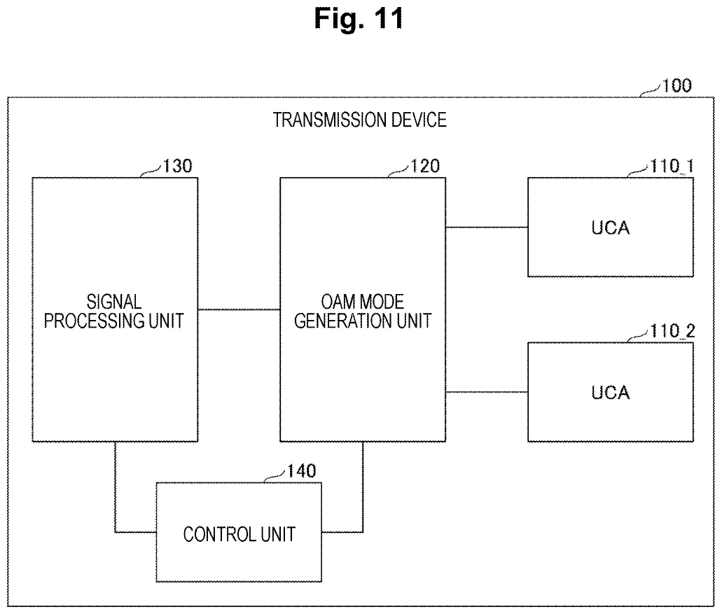

First, the transmission device 100 will be described. FIG. 11 is a diagram illustrating a configuration example of the transmission device 100 in the present embodiment. As illustrated in FIG. 11, the transmission device 100 includes a UCA 110 1, a UCA 110 2, an OAM mode generation unit 120, a signal processing unit 130, and a control unit 140. The UCA 110 1 and the UCA 110_2 correspond to the transmission UCA 1 and the transmission UCA 2 described above.

The signal processing unit 130 generates a digital signal to be transmitted on a carrier wave from input data, converts the digital signal into an analog signal (digital-analog conversion), and converts a frequency of the analog signal into a frequency band of the carrier wave (for example, 28 GHz band). The signal processing unit 130 inputs the generated analog signal to the OAM mode generation unit 120.

The OAM mode generation unit 120 generates a signal in each OAM mode and supplies the generated signal to the UCA 110 1 and the UCA 110_2. Here, the signal in the OAM mode may be a signal in the OAM mode 0 (general antenna transmission signal).

The OAM mode generation unit 120 is, for example, a Butler circuit. However, generating an OAM signal through analog processing such as in a Butler circuit is an example. An OAM mode signal may be generated through digital signal processing.

The control unit 140 receives a connection request from the UE 300, and instructs the signal processing unit 130 and the OAM mode generation unit 120 to generate a signal (OAM or MIMO) in response to the connection request. The signal processing unit 130 and the OAM mode generation unit 120 generate a signal according to the instruction.

Further, the control unit 140 receives feedback (inter-mode interference information) from the reception device 200, and instructs the signal processing unit 130 and the OAM mode generation unit 120 to generate a compensation signal based on the feedback. The signal processing unit 130 and the OAM mode generation unit 120 generate a signal according to the instruction.

### Reception Device 200

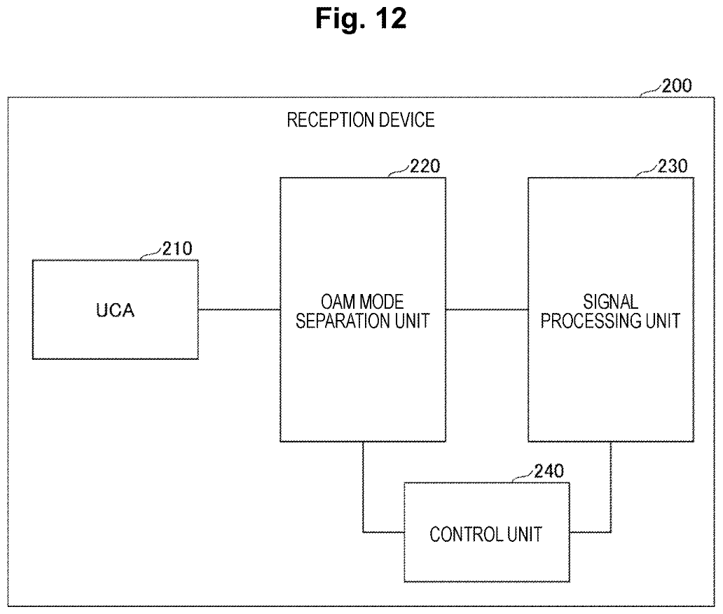

Next, the reception device 200 will be described. FIG. 12 is a diagram illustrating a configuration example of the reception device 200 in the present embodiment. As illustrated in FIG. 12, the reception device 200 includes a UCA 210, an OAM mode separation unit 220, a signal processing unit 230, and a control unit 240.

The UCA 210 corresponds to the above-described reception UCA. The OAM mode separation unit 220 includes a Butler circuit. The use of the Butler circuit for OAM mode separation is an example. OAM mode separation may be performed through digital signal processing.

The signal processing unit 230 converts the analog signal received from the OAM mode separation unit 220 (a Butler circuit is assumed) into a digital signal (analog-digital conversion), performs demodulation, and generates and outputs data (bit string).

The signal processing unit 230 performs channel estimation, a MIMO equalization process, a channel equalization process, a successive interference removal process, calculation of inter-mode interference information, and the like. The signal processing unit 230 may perform both an inter-mode interference reduction process using a compensation signal and an inter-mode interference reduction process not using the compensation signal.

The control unit 240 has a function of transmitting the inter-mode interference information calculated by the signal processing unit 230 to the transmission device 100 as feedback in addition to a function of giving an operation instruction to the OAM mode separation unit 220 and the signal processing unit 230.

### Effects of Embodiment

According to the technology related to the present embodiment described above, multidirectional support is possible and inter-mode interference between facing UCAs can be reduced in the wireless transmission technology using a UCA. It is possible to adaptively switch between multidirectional support and inter-mode interference reduction between facing UCAs. The multidirectional support and the inter-mode interference reduction between facing UCAs may be performed simultaneously.

### Summary of Embodiment

In the present specification, at least the wireless communication system, the transmission device, and the reception device described in the following clauses are described.

### Clause 1

A wireless communication system including a transmission device and a reception device, in which
the transmission device includes a plurality of UCAs having a first UCA and a second UCA, and the reception device includes a third UCA, and
a transmission axis of the first UCA and a transmission axis of the second UCA are directed in different directions, and the first UCA faces the third UCA.

### Clause 2

The wireless communication system according to clause 1, in which
the transmission device transmits a signal to a terminal present in any direction by using the second UCA.

### Clause 3

The wireless communication system according to clause 1 or 2, in which
the reception device uses a signal transmitted from the second UCA to reduce inter-mode interference between the first UCA and the third UCA.

### Clause 4

A transmission device used in a wireless communication system including the transmission device and a reception device, the transmission device including:
a plurality of UCAs having a first UCA and a second UCA, in which
a transmission axis of the first UCA and a transmission axis of the second UCA are directed in different directions, and the first UCA faces a third UCA included in the reception device.

### Clause 5

The transmission device according to clause 4, in which
the transmission device receives, from the reception device, information regarding inter-mode interference between the first UCA and the third UCA as feedback, and transmits a compensation signal for compensating for the inter-mode interference to the reception device on the basis of the feedback.

### Clause 6

A reception device used in a wireless communication system including the reception device and a transmission device including a plurality of UCAs including a first UCA and a second UCA, the reception device including:

a third UCA facing the first UCA, in which a transmission axis of the first UCA and a transmission axis of the second UCA are directed in different directions.

### Clause 7

The reception device according to clause 6, in which
a signal transmitted from the second UCA is used to reduce inter-mode interference between the first UCA and the third UCA.

Although the present embodiment has been described above, the present invention is not limited to such a specific embodiment, and various modifications and changes can be made within the scope of the concept of the present invention disclosed in the claims.

### Reference Signs List

100 Transmission device
110 UCA
120 OAM mode generation unit
130 Signal processing unit
140 Control unit
200 Reception device
210 UCA
220 OAM mode separation unit
230 Signal processing unit
240 Control unit
300 UE

1. A wireless communication system comprising:
a transmission apparatus including a first processor and a first memory that includes instructions, which when executed, cause the first processor to execute a first method; and
a reception apparatus including a second processor and a second memory that includes instructions, which when executed, cause the second processor to execute a second method, wherein
the transmission apparatus includes a plurality of uniform circular arrays (UCAs) having a first UCA and a second UCA, and the reception apparatus includes a third UCA, and
a transmission axis of the first UCA and a transmission axis of the second UCA are directed in different directions, and the first UCA faces the third UCA.

2. The wireless communication system according to claim 1, wherein the first method includes
transmitting, by the transmission apparatus, a signal to a terminal present in any direction by using the second UCA.

3. The wireless communication system according to claim 1, wherein the second method includes
using, by the reception apparatus, a signal transmitted from the second UCA to reduce inter-mode interference between the first UCA and the third UCA.

4. A transmission apparatus used in a wireless communication system including the transmission apparatus and a reception apparatus, the transmission apparatus comprising:
a processor;
a memory that includes instructions, which when executed, cause the processor to execute a method, and
a plurality of UCAs having a first UCA and a second UCA, wherein
a transmission axis of the first UCA and a transmission axis of the second UCA are directed in different directions, and the first UCA faces a third UCA included in the reception apparatus.

5. The transmission apparatus according to claim 4, wherein the method includes
receiving, by the transmission apparatus, from the reception apparatus, information regarding inter-mode interference between the first UCA and the third UCA as feedback, and transmitting a compensation signal for compensating for the inter-mode interference to the reception apparatus on the basis of the feedback.

6. A reception apparatus used in a wireless communication system including the reception apparatus and a transmission apparatus including a plurality of UCAs including a first UCA and a second UCA, the reception apparatus comprising:
a processor;
a memory that includes instructions, which when executed, cause the processor to execute a method, and
a third UCA facing the first UCA, wherein a transmission axis of the first UCA and a transmission axis of the second UCA are directed in different directions.

7. The reception apparatus according to claim 6, wherein the method includes
using a signal transmitted from the second UCA to reduce inter-mode interference between the first UCA and the third UCA.
